(19) United States
(12) Patent Application Publication
(10) Pub. No.: US 2007/0078672 A1
(43) Pub. Date: Apr. 5, 2007

(54) SYSTEM AND METHOD FOR CREATING FINALIZED LEGAL DOCUMENTS

(75) Inventors: Chung-I Lee, Tu-Cheng,Taipei Hsien (TW); Hai-Hong Lin, Shenzhen (CN); Xiao-Ping Zhang, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,211

(22) Filed: Jul. 13, 2006

(30) Foreign Application Priority Data
Aug. 12, 2005 (CN) 200510036586.8

(51) Int. Cl. G06Q 99/00; G06F 17/00

(52) U.S. Cl. 705/1; 715/530

(57) ABSTRACT

The present invention provides a method for creating finalized legal documents. The method includes the steps of: establishing a blank legal document; inputting data and inserting the data into the blank legal document; identifying the data and importing a corresponding template into the blank legal document; updating options of term and condition entries in the template; creating a primary legal document according to the data and the template; sending the primary legal document to related users for a term and condition entries review; receiving opinions reflected by the related users and integrating the opinions; determining whether any term and condition entries need to be redefined according to the opinions; and creating a finalized legal document if no term and condition entries need to be redefined. A related system is also disclosed.

### DESCRIPTION

1. Field of the Invention

The present invention relates to a system and method for creating finalized legal documents.

2. Description of Related Art

Modern complex commerce relationships involve multiple business partners and processes throughout the supply chain. This complexity affects term and condition entries corresponding to business liabilities, which relates to costs, shipments, payments, qualities, volume breaks, rebate policies, discounts, and so forth. Managing all of these (in particular if you have hosts of ever-changing partnerships) requires a serious commitment of time and resources. Today, a typical enterprise is required to communicate with a variety of vendors, suppliers, service providers, and such by using contracts, agreements, or other types of legal documents.

Legal documents are used in almost all areas of commerce. Most conventional legal documents are reviewed, accepted, and signed using an inefficient, manually irritating process. This can seriously affect the efficiency of the businesses. In recent years, software programs on legal document management have been adopted into use. However, interfaces provided by the software programs are often text-based and cumbersome to use. Furthermore, the software programs also lack functionalities that allow legal document records to be efficiently discussed, updated, and shared. The legal document records include significant events, discussions occurred during the negotiating process of individual contracts, and the completion and signing of finalized legal documents. The legal document records are generally stored in a database and accessed by a user through the interfaces each time the user needs to view it.

What is needed, therefore, is a system and method that can provide a management of each legal document through the stages of planning, negotiation, storage, maintenance, and analysis.

### SUMMARY OF THE INVENTION

A system for creating finalized legal documents is provided. The system includes a data-inputting module, a template-importing module, an editing module, a discussing module and a storing module. The data-inputting module is configured for establishing a blank legal document, for inputting data and inserting the data into the blank legal document. The template-importing module is configured for identifying the data and importing a corresponding template into the blank legal document according to the data. The editing module is configured for updating options of term and condition entries in the template and for creating a primary legal document according to the data and the template. The discussing module is configured for sending the primary legal document to related users for a term and condition entries review, for receiving opinions reflected by the related users, for integrating the opinions, and for determining whether any term and condition entries of the primary legal document need to be redefined according to the opinions. The storing module configured for creating a finalized legal document if the discussing module determines no term and condition entries needs to be redefined.

Furthermore, a method for creating finalized legal documents is provided. The method includes the steps of: establishing a blank legal document; inputting data and inserting the data into the blank legal document; identifying the data and importing a corresponding template into the blank legal document; updating options of term and condition entries in the template; creating a primary legal document according to the data and the template; sending the primary legal document to related users for a term and condition entries review; receiving opinions reflected by the related users and integrating the opinions; determining whether any term and condition entries need to be redefined according to the opinions; and creating a finalized legal document if no term and condition entries need to be redefined.

Other advantages and novel features of the present invention will become more apparent from the following detailed description of preferred embodiments when taken in conjunction with the accompanying drawings.

### BRIEF DESCRIPTION OF THE DRAWINGS

FIG. 1 is a schematic diagram of hardware configuration of a system for creating finalized legal documents in accordance with a preferred embodiment;

FIG. 2 is a schematic diagram of main software function modules of an application server of FIG. 1; and

FIG. 3 is a flowchart of a method for creating finalized legal documents in accordance with a preferred embodiment.

### DETAILED DESCRIPTION OF THE INVENTION

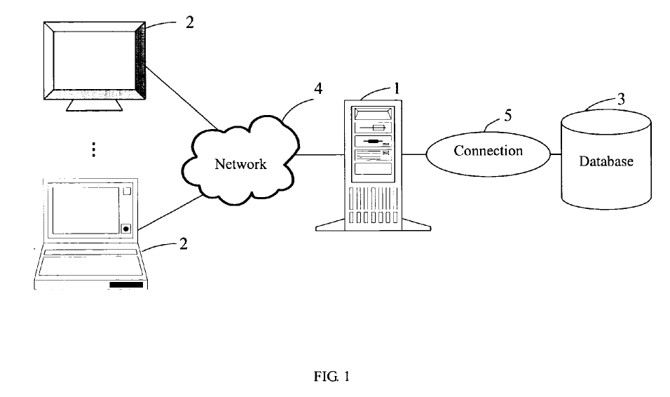

FIG. 1 is a schematic diagram of hardware configuration of a system for creating finalized legal documents (hereinafter, “the system”) in accordance with a preferred embodiment. The system includes an application server 1, a plurality of clients 2 (only two shown), and a database 3. The application server 1 communicates with the clients 2 via a network 4. The network 4 may be an intranet, the Internet, or any other types of communication link. Each client 2 is configured for providing an interactive interface enabling users to perform predetermined operations. For example, the users may create a primary legal document and discuss term and condition entries of the primary legal document with other users by using the interactive interface. The legal documents include contracts, agreements, and so on. The users may belong to different departments, such as a sales department, a purchasing department, a financial department, a legal department, or any other affiliates with an enterprise and a contracting party of the enterprise.

The application server 1 is configured for providing an administration interface to the users, and for assisting the users in creating the finalized legal document.

The application server 1 is further connected with the database 3 via a connection 5. The database 3 is configured for storing different kinds of data, such as various templates, legal documents, redefinitions of term and condition entries, opinions, and so on. The connection 5 is a database connectivity, such as an open database connectivity (ODBC) or a Java database connectivity (JDBC).

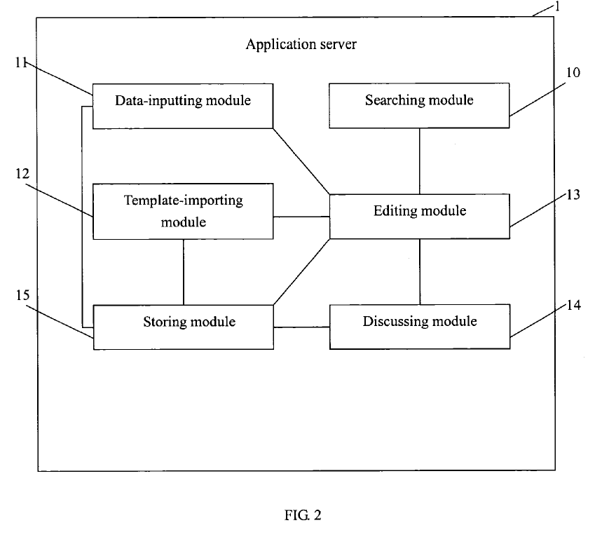

FIG. 2 is a schematic diagram of main software function modules of the application server 1. The application server 1 provides the administration interface to the clients 2, and includes a searching module 10, a data-inputting module 11, a template-importing module 12, an editing module 13, a discussing module 14, and a storing module 15.

The searching module 10 is configured for providing various queries to search for different types of legal documents, such as a blank legal document without any contents therein, a primary legal document that is ready to be sent to related users (e.g., users of the contracting party) for reviewing, and a finalized legal document that is ready to be authorized and signed etc. The queries may include a subject, a type, a serial number, a status of different types of legal documents, a product type, a product name, and so on.

The data-inputting module 11 is configured for establishing the blank legal document. The data-inputting module 11 is further configured for providing a guide on how to input corresponding data into the blank legal document, and also for inserting the corresponding data inputted by the users into the blank legal document. I.e., the guide teaches the users how to input the corresponding data, such as the enterprise name, the contracting party, a purchasing department, related users, contact information of the related users, a language of the legal document, reviewing procedures, a decision making power of a representative, and so on. The decision making power of the representative includes: strong power, medium power, and weak power. In respect to the decision making power of the representative, it is advantageous for the enterprise to negotiate with a proper corresponding representative to maximize profit.

The template-importing module 12 is configured for classifying templates by product types, contracting parties, or by other categories, and for defining term and condition entries in the different types of templates. For example, one term and condition entry may indicate that the contracting party should deliver goods to the enterprise within 2 days after the contracting party receives payment for the goods. Each template is an integrated legal document. The templates, the term and condition entries are stored in the database 3.

Each term and condition entry has an attribute, such as the attribute that allows a plurality of options to be selected, the attribute that allows only one option to be selected, and the attribute that forbids the term and condition entry to be modified etc. The template-importing module 12 is also configured for highlighting various term and condition entries with different colors according to different attributes of the term and condition entries. For example, the template-importing module 12 highlights the term and condition entries that allow a plurality of options to be selected with blue fonts, highlights the term and condition entries that allow only one option to be selected with red fonts, or highlights the term and condition entries that forbid the term and condition entries to be modified with black fonts. The template-importing module 12 is further configured for identifying the corresponding data and importing the template into the blank legal document according to the corresponding data.

The editing module 13 is configured for updating options of the term and condition entries. For example, if the term and condition entry refers to a date or a number, and the attribute of the term and condition entry allows a plurality of options to be selected, the editing module 13 may update the options of the term and condition entry according to selections by the users, wherein the options includes other predefined dates or numbers selectable by the user. After reviewing and updating options of the term and condition entries in the template, the editing module 13 is also configured for creating the primary legal document according to the corresponding data and the template. For another example, the user searches the legal document being not finalized through the searching module 10, and then edits the term and condition entries in the searched legal document through the editing module 13.

The discussing module 14 is configured for sending the primary legal document to related users (e.g., users of the enterprise and the contracting party) for further reviewing the primary legal document, and for receiving opinions reflected by the related users and displaying the opinions. The discussing module 14 is also configured for integrating the opinions, and for determining whether any term and condition entries of the primary legal document needs to be redefined according to the opinions.

The editing module 13 is further configured for redefining new contents for the term and condition entries of the primary legal document according to the opinions. Redefining the term and condition entries is not limited by their attributes.

The storing module 15 is configured for creating the finalized legal document, and for storing corresponding data, such as the input data, different types of templates, the redefinition of the term and condition entries, the opinions, and so on. The finalized legal document is ready to be authorized and signed by managers of the enterprise and the contracting party.

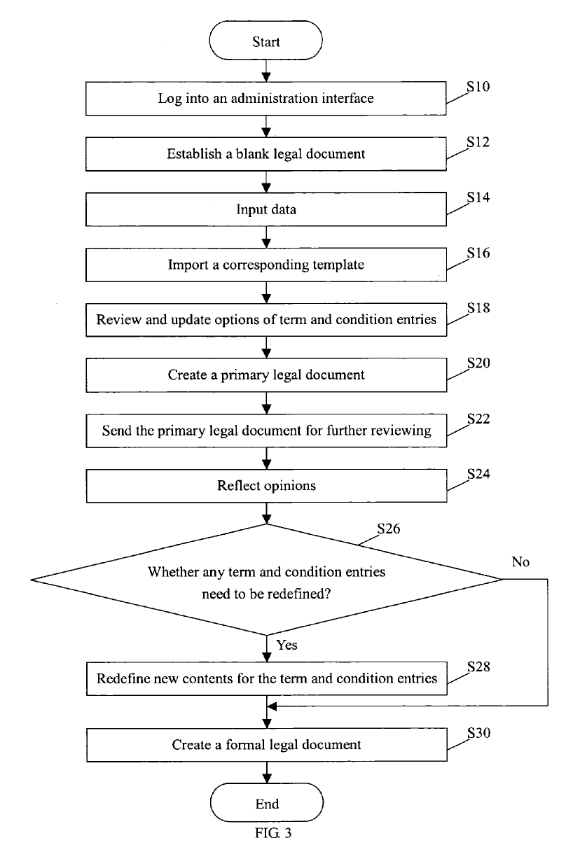

FIG. 3 is a flowchart of a method for creating the finalized legal document. In step S10, the user logs into the administration interface provided by the applicantion server 1. In step S12, the data-inputting module 11 establishes the blank legal document, generally, the searching module 10 searches the database 3 for other legal documents to be referenced before establishing the blank legal document. In step S14, the data-inputting module 11 inputs the corresponding data and inserts the corresponding data into the blank legal document.

In step S16, the template-importing module 11 identifies the corresponding data and imports the template into the blank legal document according to the corresponding data. In step S18, the user reviews the term and condition entries in the template, and the editing module 13 updates options of the term and condition entries. In step S20, the editing module 13 creates a primary legal document according to the data and the template.

In step S22, the discussing module 14 sends the primary legal document to related users for further reviewing the primary legal document. In step S24, the discussing module 14 receives and displays opinions reflected by the related users after reviewing, and integrates the opinions.

In step S26, the discussing module 14 determines whether any term and condition entries of the primary legal document need to be redefined according to the opinions. If any term and condition entries need to be redefined, in step S28, the editing module 13 redefines the new contents for the term and condition entries according to the opinions. Otherwise, if no term and condition entries need to be redefined, the procedure directly goes to step S30.

In step S30, the storing module 15 creates the finalized legal document that is ready to be signed by corresponding managers of the enterprise and the contracting party.

It should be emphasized that the above-described embodiments, particularly, any “preferred” embodiments, are merely possible examples of implementations, merely set forth for a clear understanding of the principles of the invention. Many variations and modifications may be made to the above-described preferred embodiment(s) without departing substantially from the spirit and principles of the invention. All such modifications and variations are intended to be included herein within the scope of this disclosure and the above-described preferred embodiment(s) and protected by the following claims.

What is claimed is:

1. A system for creating finalized legal documents, the system comprising:
a data-inputting module configured for establishing a blank legal document, for inputting data and inserting the data into the blank legal document;
a template-importing module configured for identifying the data and importing a corresponding template into the blank legal document according to the data;
an editing module configured for updating options of term and condition entries in the template and for creating a primary legal document according to the data and the template;
a discussing module configured for sending the primary legal document to related users for a term and condition entries review, for receiving opinions reflected by the related users, for integrating the opinions, and for determining whether any term and condition entries of the primary legal document need to be redefined according to the opinions; and
a storing module configured for creating a finalized legal document if the discussing module determines no term and condition entries needs to be redefined.

2. The system as claimed in claim 1, further comprising a searching module configured for searching for different types of legal documents.

3. The system as claimed in claim 1, wherein the data-inputting module is further configured for providing a guide on how to input data into the blank legal document.

4. The system as claimed in claim 1, wherein the template-importing module is further configured for classifying templates and defining term and condition entries in different types of templates.

5. The system as claimed in claim 1, wherein the editing module is further configured for redefining new contents for the term and condition entries of the primary legal document according to the opinions.

6. The system as claimed in claim 5, wherein the storing module is further configured for creating the finalized legal document after redefining.

7. The system as claimed in claim 1, wherein the template-importing module is further configured for highlighting the term and condition entries with different colors according to different attributes of the term and condition entries.

8. The system as claimed in claim 7, wherein the attributes of the term and condition entries comprising:
an attribute that allows a plurality of options to be selected;
an attribute that allows only one option to be selected; and
an attribute that forbids this term and condition entry to be modified.

9. A method for creating finalized legal documents, the method comprising the steps of:
establishing a blank legal document;
inputting data and inserting the data into the blank legal document;
identifying the data and importing a corresponding template into the blank legal document;
updating options of term and condition entries in the template;
creating a primary legal document according to the data and the template;
sending the primary legal document to related users for a term and condition entries review;
receiving opinions reflected by the related users and integrating the opinions;
determining whether any term and condition entries need to be redefined according to the opinions; and
creating a finalized legal document if no term and condition entries need to be redefined.

10. The method according to claim 9, further comprising the step of:
searching for different types of legal documents.

11. The method according to claim 9, further comprising the steps of:
redefining new contents for the term and condition entries if any term and condition entries need to be redefined; and
creating a finalized legal document.

12. The method according to claim 9, further comprising the steps of:
classifying the templates;
defining term and condition entries in the templates; and
highlighting the term and condition entries with different colors according to different attributes of the term and condition entries.
